(19) United States
(12) Patent Application Publication
(10) Pub. No.: US 2005/0140961 A1
(43) Pub. Date: Jun. 30, 2005

(54) Anti-vibration system, method of controlling the same, exposure apparatus, and device manufacturing method

(75) Inventors: Michio Yanagisawa, Utsunomiya-shi (JP); Toshiharu Kagawa, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/006,778

(22) Filed: Dec. 8, 2004

(30) Foreign Application Priority Data
Dec. 11, 2003 (JP) 413148/2003(PAT.)

(51) Int. Cl. G03B 27/58

(52) U.S. Cl. 355/72; 355/75

(57) ABSTRACT

Disclosed is an anti-vibration system, a method of controlling the same, and an exposure apparatus having the same. The anti-vibration system includes a gas spring, a valve provided in relation to at least one of gas supply and gas exhaust of the gas spring, a flow rate sensor disposed in a portion of a flowpassage between the gas spring and the valve, and a control system for controlling the valve on the basis of an output of the flow rate sensor

### FIELD OF THE INVENTION AND RELATED ART

This invention relates generally to anti-vibration techniques that can be applied to precision instruments or processing machines, for example.

In precision instruments such as semiconductor exposure apparatus, for example, degradation of precision due to vibration of the machine must be avoided and, to this end, transmission of vibration to the machine from its external environment such as floor, for example, should be intercepted as much as possible. It is therefore inevitable to place such a precision machine on an ant-vibration mount system. Particularly, in semiconductor exposure apparatuses, since a reticle stage or a wafer stage moves fast on a main frame of the machine, it is required for such anti-vibration mount system to assure good balance of vibration insulating performance to external vibration and vibration damping performance to internal vibration produced by the stage motion.

In order to meet such requirements, active type ant-vibration mount systems have recently been developed in practice, in which an actuator is driven in accordance with a detection signal from a vibration sensor to realize effective vibration isolation. Such active type anti-vibration systems can achieve support having well balanced vibration insulating performance and vibration damping performance, which is difficult to accomplish with passive anti-vibration mount systems consisting only of a supporting mechanism such as a mechanical spring and a damper.

Japanese Laid-Open Patent Application, Publication No. 10-256144 shows an example of anti-vibration system having a typical anti-vibration mount system. According to this document, an acceleration sensor is used as a vibration sensor for detecting vibration of an ant-vibration table, and an air spring is used as an actuator for driving the anti-vibration table. The acceleration sensor is disposed with its detection axis being oriented in a horizontal direction and a vertical direction, and it detects acceleration of the anti-vibration table in the horizontal direction and the vertical direction, respectively. The air spring supports the anti-vibration table, with its thrust producing axis being registered with the horizontal direction and the vertical direction, respectively, such that it produces and applies a thrust in the horizontal direction and a thrust in the vertical direction to the anti-vibration table. With respect to each of the horizontal direction and the vertical direction, the air spring is driven in accordance with a compensated value, provided by applying suitable compensation to a detection signal of the acceleration sensor (i.e., vibration feedback control), and thus vibration of the anti-vibration table is well suppressed.

In this type of anti-vibration mount systems, generally, a servo type acceleration sensor having a good resolving power with respect to minute vibration is used to detect vibration of the anti-vibration table. Also, for air-spring inside pressure control, a nozzle flapper (NF) type servo valve is used. The NF type servo valve is a flow rate control valve that can perform precise flow rate control at high speed, and it is suitable for use in high-performance active type anti-vibration mount systems. In the active type anti-vibration mount systems, the inside pressure of a gas spring must be controlled quickly and accurately. However, when a gas is supplied into the gas spring or a reservoir at high pressure, it may cause a change in the gas temperature. The gas temperature change which continues until the gas temperature returns to its initial temperature, may be a factor that causes a change in the inside pressure of the gas spring and, hence, it prevents accurate pressure control. As a matter of course, such change of gas temperature may occur during gas exhausting. It is therefore very important to provide an anti-vibration mount system by which the influence of gas temperature variation can be reduced to assure accurate pressure control and, hence, by which satisfactory vibration suppression is ensured.

More specifically, in anti-vibration mount systems for a microscope, for example, there are cases wherein floor-vibration feed-forward (FF) vibration insulation control is performed to reduce the influence of floor vibration as much as possible. In such case, a huge amount of gas supply and exhaust is carried out to cancel large floor vibration. This causes temperature change of the gas and it leads to prolongation of the time until the pressure is stabilized. Thus, it takes a long time for attitude stabilization of the microscope.

On the other hand, in anti-vibration mount systems for supporting the subject of vibration-insulation which is arranged to carry thereon a very heavy movable unit that moves at high speed, there are cases wherein FF vibration damping control is carried out to the moving load of the movable unit so as to suppress a change in attitude of the subject of vibration insulation to be caused by high-speed motion of the movable unit. A huge amount of gas supply and exhaust required thereto may cause a temperature change of the gas and thus a pressure change thereof. This disturbs correct moving load FF control, and it causes a difficulty of suppressing the attitude change.

As regards large-size machines, there are cases wherein the support is made by use of four or more anti-vibration mount systems (over-confinement support). In such case, the pressure of each anti-vibration mount system will be controlled appropriately, in a steady state with no external disturbance. If, however, a gas is supplied into or exhausted from a gas spring or a reservoir due to any external disturbance, a change in gas temperature produced thereby causes transitional pressure imbalance of the respective mounts, and this results in deformation stress of the subject to be vibration insulated. Particularly, in large-size machines, use of four or more anti-vibration mount systems is inevitable in many cases. Hence, it is very important to avoid the adverse influence of the deformation stress resulting from over-confinement.

Where the subject to be vibration insulated carries thereon a movable unit which moves repeatedly for a long time, the anti-vibration mount system incorporated has to perform gas supply and exhaust repeatedly for a long time. This may cause temperature drift and, then pressure drift, of the gas inside a gas spring or a reservoir, constituting the mount system. If the working point of a control valve drifts due to such pressure drift, the flow rate control characteristic of the control valve may change and, as a result, the vibration suppressing characteristic may change.

Furthermore, in a case where the subject to be vibration insulated is repeatedly floated and seated very frequently, due to temperature change it may take a long time until, when the subject is floated, the pressure is stabilized (temperature is stabilized).

As described above, the anti-vibration systems using a gas spring involve a problem of pressure change due to a change in gas temperature.

Particularly, where the subject of vibration insulated is an exposure apparatus, there are cases wherein the floor vibration FF control and the moving load FF control are carried out while four or more anti-vibration mount systems are used. Since in this case the movable unit is a very heavy stage which moves at high speed and repeatedly for a long time (for step-and-scan or step-and-repeat operation), it is a very important issue to reduce the influence of pressure variation, caused by changes in gas temperature, in the anti-vibration mount systems for an exposure apparatus.

For high-speed and accurate control of the inside pressure of a gas spring of an anti-vibration mount system, the structure of the control system as well is important, in addition to suppression of gas temperature variation. Conventionally, a pressure sensor is provided in a gas spring or a reservoir or, alternatively, in a gas control flowpassage, and an output signal of the sensor is fed back to a control valve (FB control) This is the structure of an anti-vibration mount system that comprises a small-size gas spring, a small-capacity reservoir, and a simple-configuration gas control flowpassage, and it is known that this structure in fact provides relatively good results if external vibration such as floor vibration or internal vibration due to the influence of a movable unit is small. However, if the size of gas spring or reservoir becomes large, the delay of pressure response is prolonged. It becomes therefore difficult to achieve high speed and accurate control by use of the structure that only the pressure is detected to control the control valve. Moreover, since it would be an FB control system having large time constant, if the FB gain is enlarged to get higher speed, the influence of noise or offset drift of the pressure sensor would be serious. Hence, the pressure control deviation could not be reduced and, to the contrary, it may be enlarged. The result would be worse where the output of the pressure sensor is easily influenced by the temperature change.

In the pressure FB control system, attention should be paid to the disposition of a pressure sensor. Where a pressure sensor is disposed in a gas control flowpassage, it must be provided very carefully, otherwise the frequency region for enabling precise detection of pressure change would be extremely narrowed due to the influence of pipe resonance, for example.

As described above, in anti-vibration mount systems using a gas spring, in order to accomplish high speed and very accurate pressure control, there still remain many problems to be solved, particularly in relation to the structure of the control system.

Furthermore, there is a problem in relation to gas consumption. Since the NF type servo valve has good response as described hereinbefore, it is used as a control valve of anti-vibration mount systems. However, the NF type servo valve uses a large normal gas displacement. Namely, the amount of gas consumption thereof is huge. Therefore, if, for example, a large size and large flow-rate NF type servo valve is used to control a large size anti-vibration mount system, the running cost would be very expensive although high response could be realized by consuming a huge amount of high pressure gas.

### SUMMARY OF THE INVENTION

It is accordingly an object of the present invention to provide an anti-vibration technique using a gas spring, by which high speed and very precise control are enabled.

It is another object of the present invention to provide an anti-vibration system and/or an anti-vibration method by which at least one of the inconveniences described above can be avoided or reduced.

In accordance with an aspect of the present invention, there is provided an anti-vibration system, comprising: a gas spring; a valve provided in relation to at least one of gas supply and gas exhaust of said gas spring a flow rate sensor disposed in a portion of a flowpassage between said gas spring and said valve; and a control system for controlling said valve on the basis of an output of said flow rate sensor.

In accordance with another aspect of the present invention, there is provided a method of controlling an anti-vibration system having a gas spring and a valve provided in relation to at least one of gas supply and gas exhaust of the gas spring, said method comprising the steps of: detecting a flow rate in a flowpassage between the gas spring and the valve; and controlling the valve on the basis of the flow rate detected at said detecting step.

In accordance with a further aspect of the present invention, there is provided an anti-vibration system, comprising: a gas spring; a valve provided in relation to at least one of gas supply and gas exhaust of said gas spring; a control system for controlling said valve on the basis of an output of said flow rate sensor; and a heat accumulating material disposed inside said gas spring.

Briefly, in accordance with the present invention, an anti-vibration technique using a gas spring, by which high speed and high precision control is enabled, is accomplished.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view of a basic structure of an anti-vibration mount system according to a first embodiment of the present invention.

FIG. 2 is a schematic view of an example of non-steady flow-rate measuring means, according to the present invention.

FIG. 3 is a schematic view of an anti-vibration system according to a second embodiment of the present invention, which is arranged to perform floor-vibration feed-forward.

FIG. 4 is a schematic view of an anti-vibration system according to a third embodiment of the present invention, which is arranged to perform stage drive signal feed-forward.

FIG. 5 is a schematic view of an anti-vibration system according to a fourth embodiment of the present invention, which is arranged to perform pressure feedback.

FIG. 6 is a perspective view, showing an example of flow regulating element of non-steady flow-rate measuring means according to the present invention.

FIG. 7 is a schematic view of an anti-vibration system according to a fifth embodiment of the present invention, wherein an electric-pneumatic converting element is used in gas supply and exhaust control means.

FIG. 8 is a schematic view of an anti-vibration system according to a sixth embodiment of the present invention, wherein a spool valve is used in gas supply and exhaust control means.

FIG. 9 is a schematic view of an exposure apparatus to which the present invention can be applied.

FIG. 10 is a flow chart for explaining device manufacturing processes.

### DESCRIPTION OF THE PREFERRED EMBODIMENTS

Preferred embodiments of the present invention will now be described with reference to the attached drawings.

[Embodiment 1]

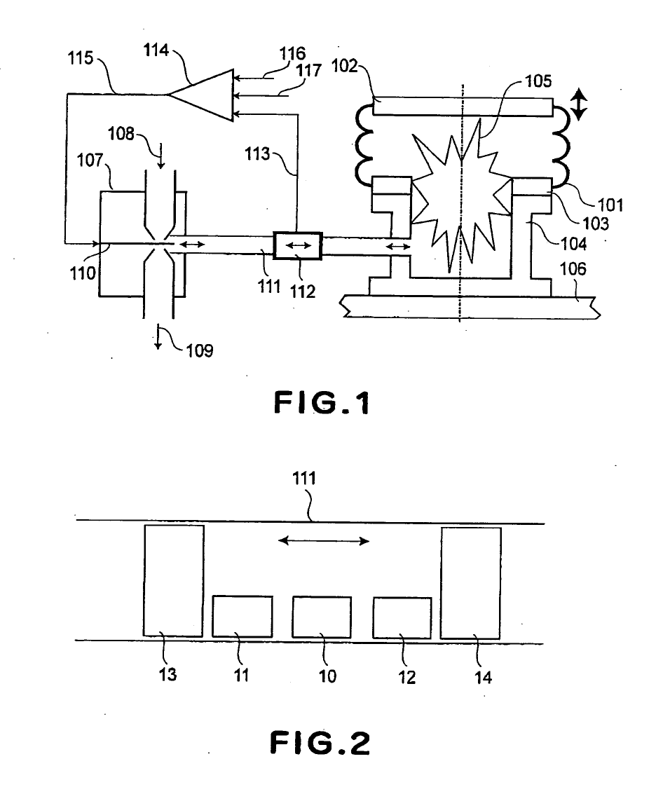

FIG. 1 shows a basic structure of an anti-vibration mount system according to a first embodiment of the present invention.

In FIG. 1, an elastic film 101 is made from a thin rubber, for example, which is shaped into an approximately cylindrical configuration such as bellows shape, for example. End plates 102 and 103 are attached to the opposite ends of the bellows, whereby a gas spring is constituted. A reservoir 104 is connected and communicated with the gas spring, and a heat accumulating material 105 loaded inside the reservoir and the gas spring. Denoted at 106 is a floor for placement and, generally, the reservoir 104 is firmly connected thereto. There is a control flowpassage 111 between the reservoir 104 and a servo valve 107. A bidirectional flow-rate sensor 112 as a non-steady flow-rate measuring means is provided in the control flowpassage 111. An output signal 113 of the sensor 112 is applied to a control circuit 114, and a flapper 110 of the servo valve 107 (gas supply and exhaust control means) is actuated in response to an output signal 115 of the control circuit 114. By controlling the flapper 110 position with respect to gas supply 108, the amount of gas exhaust (displacement) 109 is controlled and, as a result of it, the inside pressure of the reservoir 104 and of the elastic film 101 constituting the gas spring is controlled.

As a general structure of an anti-vibration mount system, there is a position sensor that measures the position of the end plate 102 while taking the floor 106 as a reference, and a vibration sensor as well provided on the end plate 102. Output signals 116 and 117 of these sensors are applied together with the output signal 113 to the control circuit 114. In this control circuit 114, an appropriate filtering operation or adding operation, for example, is carried out, whereby vibration control is performed. Generally, a plurality of anti-vibration mount systems having a structure such as described above are used to support a machine which is the subject of vibration insulation. Although three-point support is common, four or more support points are used where the machine is large in size. Only one or two points may be supported by use of anti-vibration mount systems, and a mechanical spring or any other supporting mechanism may be used for the other points. An anti-vibration mount system may be used for vibration insulation and damping with respect to a horizontal direction of the machine.

As regards the elastic film 101, preferably it should be less stretchable but well flexible. Thus, a film made from integrally laminated cloth and rubber is usable. In many cases, a bellows shape will provide good vibration insulation performance. A rubber diaphragm may be used as the elastic film 101. In an application wherein outgassing is undesirable, such as in a vacuum machine, for example, in order to avoid outgassing from rubber, a metal bellows may be used to provide a gas spring.

The position sensor and the vibration sensor as well as signal processing operations therefor are conventional, and they are not illustrated in the drawings. Detailed description of them will be omitted here. This is also with the case of embodiments to be described later.

FIG. 2 shows an example of the structure of a bidirectional flow-rate sensor. Specifically, a heater 10, temperature sensors 11 and 12, and flow regulating (rectifying) elements 13 and 14 are disposed in the control flowpassage 111. While keeping the heater 10 at its heating state, the flow rate inside the control flowpassage 111 can be detected from the temperature difference between the positions of the temperature sensors 11 and 12.

[Embodiment 2]

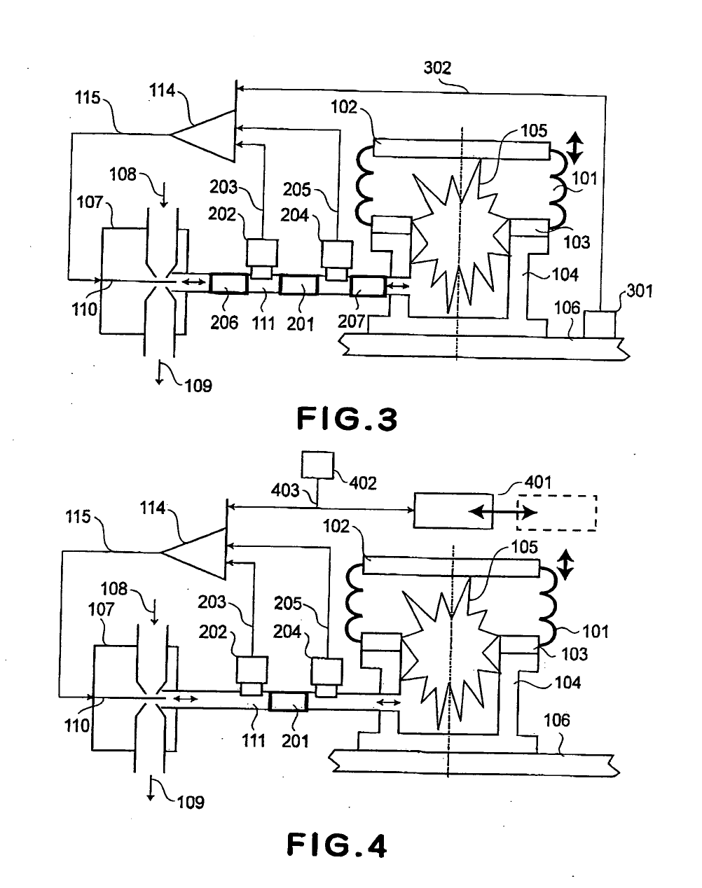

FIG. 3 shows an anti-vibration mount system according to a second embodiment of the present invention, which is arranged to perform floor-vibration FF (feed-forward). In FIG. 3, components corresponding to those of FIG. 1 are denoted by similar reference numerals. Duplicate description for these components will be omitted.

In this anti-vibration mount system, an output signal 302 of a vibration sensor 301 provided on the machine mounted floor 106 is processed by a control circuit 114 and, based on this, a servo valve 107 is controlled to reduce the amount of floor vibration to be transmitted to the machine. For example, if a large vibration of the floor 106 occurs accidentally, despite execution of huge amount of gas supply and exhaust through the servo valve 107, the system is arranged so that inside temperature change less occurs in the gas spring (elastic film 101) and the reservoir 104 and the pressure can be well controlled and that, through the flow-rate FB (feedback) using non-steady flow-rate measuring means, vibration can be suppressed more satisfactorily.

The non-steady flow-rate measuring means of this embodiment comprises a flow regulating (rectifying) element 201, and pressure sensors 202 and 204 provided at the opposite sides of the flow regulating element 201. Output signals 203 and 205 of these sensors are applied to the control circuit 114. As shown in FIG. 6, the flow regulating element 201 comprises a plurality of thin pipes 601 disposed in parallel to each other. The flow rate inside the control flowpassage 111 can be calculated from the pressure difference between the opposite ends of the flow regulating element 201, that is, on the basis of the output signals 203 and 205. As shown in FIG. 3, additional flow regulating elements 206 and 207 may be provided on the opposite sides of the pressure sensors 202 and 204, and this may contribute to further improvement of the flow-rate measuring precision.

[Embodiment 3]

FIG. 4 shows an anti-vibration mount system according to a third embodiment of the present invention, which is arranged to support a machine having a movable stage (movable member). In FIG. 4, components corresponding to those of FIGS. 1 and 3 are denoted by like reference numerals, and duplicate description therefor will be omitted.

The movable stage 401 supported by the anti-vibration mount system is controlled in accordance with a stage drive signal 403 supplied from a stage control circuit 402, and it is movable on the machine, namely, on the anti-vibration mount system. Where plural anti-vibration mount systems are used to support the machine, the support load of each anti-vibration mount system varies with the motion of the stage 401. Thus, an appropriate stage drive signal 403 is applied to each control circuit 114 of the respective anti-vibration mount systems to accomplish the moving load FF control, thereby to reduce attitude change or vibration of the machine. Such stage driving signal 403 may be used to accomplish vibration suppression as well through the FF control of moment or reactive force, not only for the moving load.

[Embodiment 4]

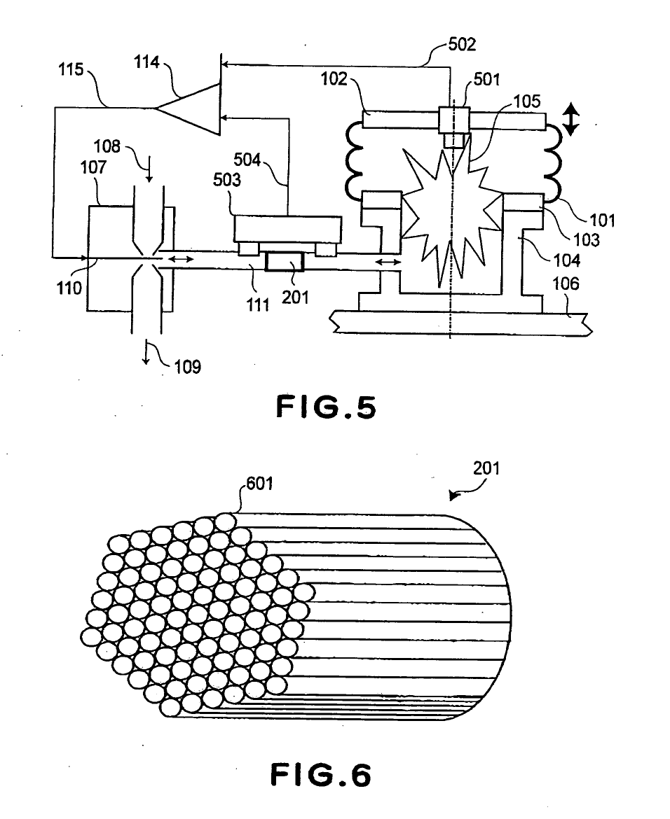

FIG. 5 shows an anti-vibration mount system according to a fourth embodiment of the present invention, wherein a pressure sensor for measuring the inside pressure of a gas spring is provided. In FIG. 5, components corresponding to those of FIGS. 1 and 3 are denoted by like reference numerals, and duplicate description therefor will be omitted.

In this anti-vibration mount system, an output signal 502 of a pressure sensor 501 is applied to a control circuit 114, thereby to perform the pressure FB control. As compared with conventional systems wherein the pressure FB control is performed only by use of a pressure sensor 501, more precise pressure control is enabled and thus an anti-vibration mount system of higher performance is accomplished. This embodiment is an example wherein a differential pressure detecting sensor is used as a bidirectional flow-rate sensor. In this case, the flow rate inside a control flowpassage 111 is calculated on the basis of a differential pressure signal 504 of a differential pressure detecting sensor 503 obtainable by detecting the pressure difference between the opposite ends of a flow regulating element 201.

The second, third and fourth embodiments described above with reference to FIGS. 3, 4 and 5 may be combined appropriately when the present invention is embodied. For example, the floor-vibration FF and the stage drive signal FF may be combined, or the stage drive signal FF and the pressure FB may be combined.

[Embodiment 5]

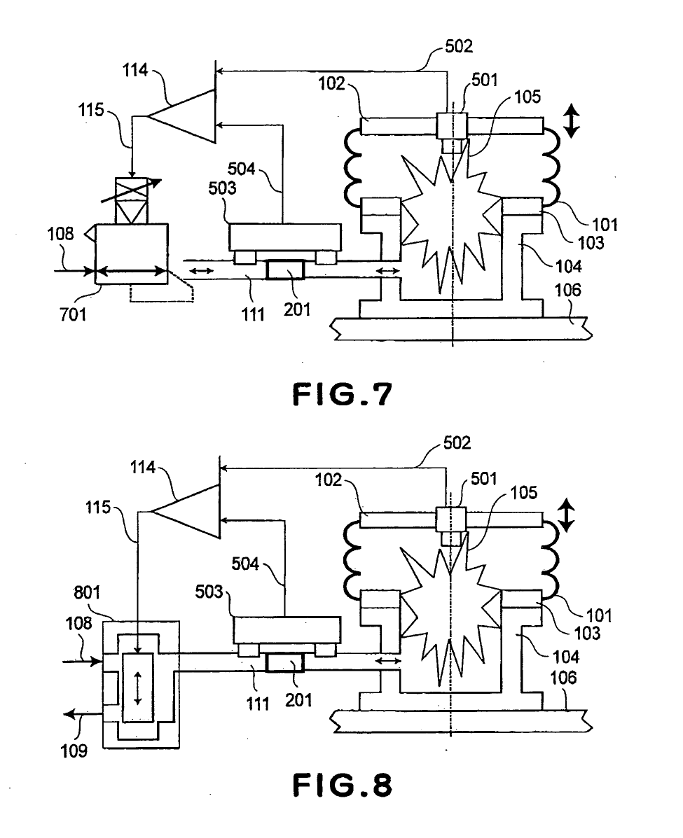

FIG. 7 shows an anti-vibration mount system according to a fifth embodiment of the present invention, wherein an electric-pneumatic converting element (an electrically controlled pressure reducing valve) 701 is used as gas supply and exhaust control means. In FIG. 7, components corresponding to those of FIG. 5 are denoted by like reference numerals, and duplicate description therefor will be omitted.

The electropneumatic changing element 701 which is a control valve for controlling the pressure of a gas in the anti-vibration mount system of this embodiment has features different from the NF type servo valve, that high precision pressure control can be done where the pressure of load is controlled at a slow speed and that a large control flow rate can be assured with small steady displacement. However, in some cases, it is not suitable to applications wherein the pressure is to be dynamically controlled. Particularly, even if a drive signal is applied to the electropneumatlc converter and high-speed gas supply and exhaust is carried out in an attempt to accomplish the pressure control as required for the anti-vibration mount system, there will arise a problem of non-linearity of the pressure control at the time of switching between gas supply and gas exhaust. In many cases, precise pressure control is difficult to achieve, and satisfactory vibration suppression is unattainable. With the structure shown in FIG. 7, as compared therewith, because of the flow-rate FB control, the influence of non-linearity of the electropneumatic changing element 701 can be well reduced, and accurate pressure control can be done. Furthermore, with the structure of this embodiment, temperature changes inside the gas spring and the reservoir 104 are reduced. Therefore, the advantageous feature of the electropneumatic converting element 701 that a large control flow rate is assured can be used in high-speed pressure control, and good results are obtainable.

[Embodiment 6]

FIG. 8 shows an anti-vibration mount system according to a sixth embodiment of the present invention, wherein a spool valve 801 is used as gas supply and exhaust control means. In FIG. 8, components corresponding to those of FIG. 7 are denoted by like reference numerals, and duplicate description therefor will be omitted.

The spool valve 801 of this anti-vibration mount system is a valve that controls the degree of opening of the flowpassage, and it may be straight-motion type or rotary type. Where it is used for pressure control of an anti-vibration mount system, the structure shown in FIG. 8 can be used. As a structurally inevitable characteristic of the spool valve 801, there is non-linearity of the flow rate control characteristic at around the changeover of gas supply 108 and gas exhaust 109. In this embodiment, however, because of the flow-rate FB control, high-precision pressure control is enabled and good results are obtainable as well.

In the first to sixth embodiments described hereinbefore, the following modifications are possible. The gas supply and exhaust control flowpassage may be connected to the gas spring, not to the reservoir. Although use of an air as the control gas is common, nitrogen may be used, for example. An actuator such as linear motor may be used in combination, to apply a force to a machine (subject to be vibration insulated) from the floor to assist the gas spring of the anti-vibration mount system.

A reservoir may be added in a gas supply flowpassage of the control valve, for stabilization of the gas supply pressure. The inside space of the reservoir may be filled with a heat accumulating material. The heat accumulating material in this case as well may be thin wire members. The control valve may be pneumatic controlled type, other than electrically controlled type. An anti-vibration mount system of the present invention can be applied also to a vehicle frame or an engine mount, for example.

In one preferred form of the present invention, the invention can be embodied as an anti-vibration mount system having a gas spring for reducing transmission of external vibration such as vibration of a floor where a precision instrument or a processing machine is placed and also for reducing vibration caused by the motion of a movable unit which is mounted on the machine itself, wherein the mount system includes gas supply and exhaust control means for controlling the gas spring and a reservoir as well as gas supply and exhaust of them, heat accumulating means having a large surface area and being disposed in an inside space of at least one of the gas spring and the reservoir, and non-steady flow-rate measuring means disposed in a gas control flowpassage from the gas supply and exhaust control means to the gas spring or reservoir and being arranged to measure bidirectional flow rate. The gas supply and exhaust control means may be controlled on the basis of an output signal of the non-steady flow-rate measuring means. A heat accumulating material as the heat accumulating means may be evenly loaded, without unevenness, inside the gas spring or reservoir, and preferably it may have a heat conductivity of not less than 0.05 W/mK.

The heat accumulating material as the heat accumulating means may comprise thin wires. The thin wires may be loaded at random inside the gas spring or reservoir to make larger the contact area between the wires and the air of the inside space of the gas spring or reservoir. The wire diameter may preferably be thinner as it leads to enlargement of the surface area per volume. A diameter not greater than 50 μm will be effective, and a diameter not less than 10 μm will be practical from the standpoint of strength.

The non-steady flow-rate measuring means may comprise a flow regulating element having a plurality of thin pipes juxtaposed with each other, for example, and sensors disposed at openings at the opposite ends of the flow regulating element to detect the state of gas there. In that occasion, the flow rate can be calculated on the basis of output signals of these sensors.

The sensors may be a sensor that detects either pressure or temperature, and they may be used to detect a pressure difference or temperature difference between the openings at the opposite ends. The flow rate can be calculated on the basis of either the pressure difference or the temperature difference.

In one preferred form of the present invention, an inside pressure measuring means may be provided in any one of the gas spring, the reservoir and the gas control flowpassage. The gas supply and exhaust control means may be controlled on the basis of an output signal of this measuring means.

The gas supply and exhaust control means may include a control valve having a function for controlling the opening degree of the flowpassage or the pressure thereof. A nozzle flapper type servo valve, an electro-pneumatic converting element or a spool valve may be used therefor.

In one preferred form of anti-vibration mount system according to the present invention, a subject to be vibration insulated is supported by means of a gas spring. If the inside pressure of a gas spring or a reservoir connected thereto is raised or reduced rapidly, the inside temperature may change largely. However, by loading an appropriate heat accumulating material inside the gas spring or the reservoir as heat accumulating means, the change of inside temperature can be reduced and thus the pressure change due to temperature change can be reduced. Therefore, high-speed and high-precision pressure control can be achieved easily. A control valve for performing gas supply and exhaust to pressurize or depressurize the gas spring or the reservoir, and a non-steady flow-rate measuring means for measuring bidirectional flow rate of a control flowpassage that connects the control valve to the gas spring or the reservoir, may be provided. By controlling the control valve on the basis of an output signal of this measuring means, higher speed pressure control can be done with good precision. Namely, since the flow rate hysteresis of the control flowpassage is one factor that determines the inside pressure of the gas spring and the reservoir, measuring the flow rate precisely and controlling the pressure on the basis of the measurement result is very effective to assure high speed and high precision control of the pressure.

The heat accumulating material of the heat accumulating means is provided primarily for heat transfer with the gas. Thus, a larger surface area can provide a better result. On the other hand, in order to avoid undesirable largeness in size of the gas spring or reservoir, that is, bulkiness of the machine, the volume of the heat accumulating material should be as small as possible. Thus, the surface area per volume should preferably be made large. As regards the loading of the heat accumulating material, metal or resin wire materials may preferably be loaded at random inside the gas spring or reservoir so as to make uniform the inside pressure of the gas spring or reservoir. This assures effective heat transfer, and inside temperature of the gas spring or the reservoir can be made even at the time of compression and expansion. Metal or resin wire materials may be loaded in the form of steel wool (metal cotton). In that occasion, the heat accumulating material can be loaded throughout the whole inside pace without producing resistance to expansion/contraction of the gas spring, and good results are obtainable.

As regards the measuring means for non-steady flow rate, small-diameter pipes may be provided in parallel to each other inside the control flowpassage, and pressure sensors may be provided at the opposite ends of the pipes to measure the pressures there. The flow rate can be calculated accurately on the basis of the pressure difference.

As an alternative of measuring the non-steady flow rate, a plurality of temperature sensors and a heater may be provided inside the control flowpassage. The flow rate can be detected on the basis of a difference between output signals of the temperature sensors.

In one preferred from of the present invention, a non-steady flow-rate measuring means for a gas control flowpassage is provided, and gas supply and exhaust control means is controlled on the basis of an output signal of the measuring means. The system is therefore less influenced by a delay of pressure response due to the capacity of the gas spring or the reservoir (which leads to a serious problem in a case where the pressure of the gas spring or reservoir is simply detected for feedback control), and thus a wide-range pressure control is enabled. Furthermore, in conventional techniques, depending on the placement or structure of the pressure detecting means, wide-range accurate pressure detection is unattainable due to the influence of pipe resonance, and the pressure feedback control does not function well. As compared therewith, if the pressure feedback control based on the non-steady flow-rate feedback of the present invention is carried out in combination, good results are obtainable.

An anti-vibration mount system according to one preferred form of the present invention includes a non-steady flow-rate measuring means in a control flowpassage, and the flow-rate feedback control is carried out on the basis of an output signal of the measuring means. With this arrangement, good pressure control is attainable even if a control valve for which the control of linearity at the time of changeover of gas supply and gas exhaust is not easy, such as an electropneumatic changing element or a spool valve, for example, is used. Thus, the control valve can be chosen from a relatively wide range.

In one preferred form of the present invention, the invention can be embodied as an anti-vibration mount system having gas supply and exhaust control means for controlling gas supply and exhaust of a gas spring and a reservoir, wherein the inside space of the gas spring or the reservoir may be filled with a heat accumulating material being large in surface area and small in volume. With this structure, the gas temperature less changes during gas supply and gas exhaust (temperature regulating effect). As a result, the pressure change due to temperature change is reduced, and precise pressure control is assured.

For example, even if a huge amount of gas supply and exhaust is carried out in response to a large floor vibration when the floor vibration feed-forward anti-vibration control is performed, the temperature change to be produced thereby can be made small such that the time necessary for convergence of transitional pressure variation can be made short. In an anti-vibration mount for supporting a microscope, for example, floor vibration feed-forward may be carried out to make the vibration level as low as possible. In such case, with the present invention, the vibration level can be lowered stably.

When the invention is applied to a subject to be vibration insulated which carries thereon a very heavy movable unit being movable at high speed, temperature changes of the gas due to huge amount of gas supply and exhaust involved in the moving load feed-forward of the movable unit, being carried out to suppress attitude change of the subject of vibration insulation caused by high speed motion thereof, can be reduced effectively. Therefore, a pressure change less occurs as a result of it, and thus attitude change suppression based on appropriate moving load feed forward is enabled. In machine tools wherein precise machining is required, reduction of floor vibration transmission and reduction in attitude change of the machine itself should be satisfied at the same time. In addition, high-speed motion of the movable unit should be satisfied. These requirements are well satisfied by the present invention.

In the case of over-confinement form wherein the support is carried out by use of four or more anti-vibration mount systems, transitional pressure imbalance of the mounts resulting from gas temperature changes can be reduced, and thus the deformation stress to the subject of vibration insulation can be suppressed. Particularly, for large-size machines, in many cases the use of four or more anti-vibration mount systems is inevitable. It is therefore very important to avoid adverse influences of the deformation stress due to over-confinement. With the present invention, as compared with conventional techniques, such transitional deformation stress can be reduced effectively.

Furthermore, in the case where a subject of vibration insulation carries thereon a movable unit which moves repeatedly for a very long time, the anti-vibration mount system incorporated has to perform gas supply and exhaust repeatedly for a long time. This may cause temperature drift change of the gas inside a gas spring or a reservoir, constituting the mount system, and thus it is difficult to avoid pressure drift therein. However, with the structure of the present invention, the pressure drift can be reduced. Even if the subject to be vibration insulated is repeatedly floated and seated very frequently, the time necessary for pressure stabilization when the subject is floated can be shortened.

Particularly, when the subject of vibration insulation is an exposure apparatus, there are cases where the floor vibration feed-forward and moving load feed-forward are carried out and the support is made by use of four or more anti-vibration mount systems. In such cases, the movable unit is a very heavy stage which moves repeatedly at high speed for a long time (for step-and-scan or step-and-repeat operation). Thus, when anti-vibration mount systems according to the present invention, capable of reducing the influence of pressure change resulting from gas temperature change, are used, the vibration level can be controlled very well and a high-performance exposure apparatus can be achieved.

Thin wire materials may be used as a heat accumulating material, and they may be loaded at random inside the gas spring or the reservoir. Temperature regulating effect can be accomplished with good efficiency. Where the inside space of the gas spring is filled with a heat accumulating material, it less produces deformation resistance to the gas spring and, therefore, it is particularly preferable and effective for use in an anti-vibration mount system.

In one preferred form of the present invention, a non-steady flow-rate measuring means is provided in relation to the gas control flowpassage, and gas supply and exhaust control means is controlled on the basis of an output signal of the measuring means. The pressure control is therefore less influenced by a delay of pressure response due to the capacity of the gas spring or the reservoir (which leads to a serious problem in a case where the pressure of the gas spring or reservoir is simply detected for feedback control).

Furthermore, in conventional pressure feedback techniques, depending on the placement or structure of the pressure detecting means, wide-range accurate pressure detection is unattainable due to the influence of pipe resonance, for example, and the pressure feedback control does not function well. As compared therewith, when the pressure feedback control based on the non-steady flow-rate feedback of the present invention is carried out in combination, good results are obtainable.

As a specific structure of the non-steady flow-rate measuring means, it may comprise a flow regulating element having small-diameter pipes disposed in parallel to each other, and pressure sensors provided at the opposite ends of the flow regulating element. By calculating the flow rate on the basis of the output signals of these sensors, bidirectional non-steady flow rate can be measured quickly and precisely. This provides a significant effect of improving the performance an anti-vibration mount system.

In the present invention, an electropneumatic converting element or spool valve, having smaller gas consumption, may be used, and high precision gas supply and exhaust control is still attainable in that occasion. Therefore, the running cost of the anti-vibration mount system can be decreased.

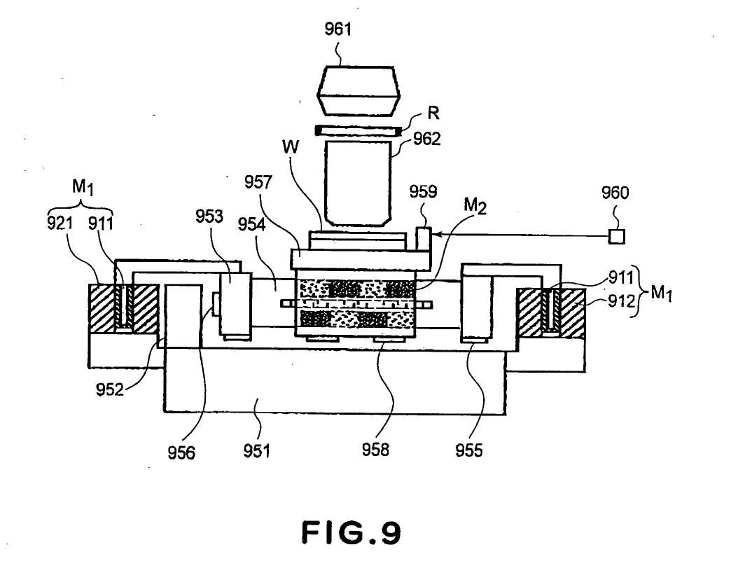

FIG. 9 shows an exposure apparatus for device manufacture, into which an anti-vibration mount system as described hereinbefore is incorporated.

This exposure apparatus is to be used for manufacture of microdevices having a fine pattern formed thereon, such as semiconductor devices (semiconductor integrated circuits, for example), micromachines, or thin-film magnetic heads, for example. In this exposure apparatus, exposure light (which may include visible light, ultraviolet light, EUV light, X-ray, electron beam, and charged particle beam, for example) as an exposure energy supplied from a light source 961 illuminates a reticle R , and light from the reticle R is projected onto a semiconductor wafer W (substrate) through a projection system having a projection lens 962 (which may include refractive lens, reflective lens, catadioptric lens system, and charged particle lens, for example), whereby a desired pattern is produced on the substrate.

The exposure apparatus includes a base table 951 having a guide 952 and a linear motor stator 921 fixed thereto. The linear motor stator 921 has a multiple-phase electromagnetic coil, while a linear motor movable element 911 includes a permanent magnet group. The linear motor movable portion 911 is connected as a movable portion 953 to a movable guide 954 (stage), and through the drive of the linear motor M1, the movable guide 954 can be moved in a direction of a normal to the sheet of the drawing. The movable portion 953 is supported by a static bearing 955, taking the upper surface of the base table 951 as a reference, and also by a static bearing 956, taking the side surface of the guide 952 as a reference.

A movable stage 957 which is a stage member disposed to straddle the movable guide 954 is supported by a static bearing 958. This movable stage 957 is driven by a similar linear motor M2, so that the movable stage 957 moves leftwardly and rightwardly as viewed in the drawing, while taking the movable guide 954 as a reference. The motion of the movable stage 957 is measured by means of an interferometer 960 and a mirror 959 which is fixed to the movable stage 959.

A wafer (substrate) W is held on a chuck which is mounted on the movable stage 957, and a pattern of the reticle R is transferred in a reduced scale onto different regions on the wafer W by means of the light source 961 and the projection optical system 962, in accordance with a step-and-repeat method or a step-and-scan method.

It should be noted that the substrate attracting device described hereinbefore can be similarly applied also to an exposure apparatus in which, without using a mask, a circuit pattern is directly drawn on a semiconductor wafer to expose a resist thereon.

Next, an embodiment of a semiconductor device manufacturing processes, using an exposure apparatus described above, will be explained.

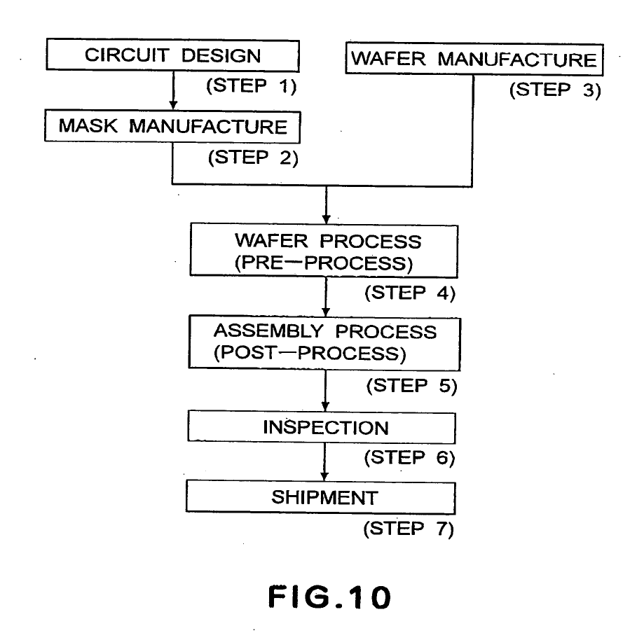

FIG. 10 is a flow chart for explaining the overall procedure for semiconductor manufacture. Step 1 is a design process for designing a circuit of a semiconductor device. Step 2 is a process for making a mask on the basis of the circuit pattern design. Step 3 is a process for preparing a wafer by using a material such as silicon. Step 4 is a wafer process which is called a pre-process wherein, by using the thus prepared mask and wafer, a circuit is formed on the wafer in practice, in accordance with lithography. Step 5 subsequent to this is an assembling step which is called a post-process wherein the wafer having been processed at step 4 is formed into semiconductor chips. This step includes an assembling (dicing and bonding) process and a packaging (chip sealing) process. Step 6 is an inspection step wherein an operation check, a durability check an so on, for the semiconductor devices produced by step 5, are carried out. With these processes, semiconductor devices are produced, and they are shipped (step 7).

More specifically, the wafer process at step 4 described above includes: (i) an oxidation process for oxidizing the surface of a wafer; (ii) a CVD process for forming an insulating film on the wafer surface; (iii) an electrode forming process for forming electrodes upon the wafer by vapor deposition; (iv) an ion implanting process for implanting ions to the wafer; (v) a resist process for applying a resist (photosensitive material) to the wafer: (vi) an exposure process for printing, by exposure, the circuit pattern of the mask on the wafer through the exposure apparatus described above: (vii) a developing process for developing the exposed wafer; (viii) an etching process for removing portions other than the developed resist image; and (ix) a resist separation process for separating the resist material remaining on the wafer after being subjected to the etching process. By repeating these processes, circuit patterns are superposedly formed on the wafer.

While the invention has been described with reference to the structures disclosed herein, it is not confined to the details set forth and this application is intended to cover such modifications or changes as may come within the purposes of the improvements or the scope of the following claims.

This application claims priority from Japanese Patent Application No. 2003-413148 filed Dec. 11, 2003, for which is hereby incorporated by reference.

1. An anti-vibration system, comprising:
a gas spring;
a valve provided in relation to at least one of gas supply and gas exhaust of said gas spring;
a flow rate sensor disposed in a portion of a flowpassage between said gas spring and said valve; and
a control system for controlling said valve on the basis of an output of said flow rate sensor.

2. An anti-vibration system according to claim 1, further comprising a heat accumulating material disposed in said gas spring.

3. An anti-vibration system according to claim 1, wherein said flow rate sensor is operable to measure a flow rate in each of opposite directions along said flowpassage.

4. An anti-vibration system according to claim 1, wherein said flow rate sensor includes a heater inside said flowpassage, two temperature sensors provided along said flowpassage and being disposed at the opposite sides of said heater, and two flow regulating elements provided along said flowpassage and being disposed to sandwich said two temperature sensors between them.

5. An anti-vibration system according to claim 1, wherein said flow rate sensor includes a flow regulating element, and two pressure sensors provided along said flowpassage and being disposed at the opposite sides of said flow regulating element.

6. An anti-vibration system according to claim 1, wherein said valve is one of servo valve, pressure reducing valve and spool valve.

7. An anti-vibration system according to claim 1, wherein said control system controls said valve on the basis of at least one of (a) an output of a position sensor for detecting the position of a subject to be vibration insulated, (b) an output of a first vibration sensor for detecting vibration of the subject to be vibration insulated, (c) an output of a second vibration sensor for detecting vibration of a floor, (d) an output of a pressure sensor for detecting an inside pressure of said gas spring, and (e) a drive signal for a movable member that is contained in the subject to be vibration insulated.

8. An exposure apparatus, comprising:
a pattern transfer system for transferring a pattern onto a substrate; and
an anti-vibration system as recited in claim 1.

9. A device manufacturing method, comprising the steps of:
transferring a pattern onto a substrate by use of an exposure apparatus as recited in claim 8; and
developing the substrate having the pattern transferred thereto.

10. A method of controlling an anti-vibration system having a gas spring and a valve provided in relation to at least one of gas supply and gas exhaust of the gas spring, said method comprising the steps of:
detecting a flow rate in a flowpassage between the gas spring and the valve; and
controlling the valve on the basis of the flow rate detected at said detecting step.

11. An anti-vibration system, comprising:
a gas spring;
a valve provided in relation to at least one of gas supply and gas exhaust of said gas spring;
a control system for controlling said valve on the basis of an output of said flow rate sensor; and
a heat accumulating material disposed inside said gas spring.

12. An exposure apparatus, comprising:
a pattern transfer system for transferring a pattern onto a substrate; and
an anti-vibration system as recited in claim 11.

13. A device manufacturing method, comprising the steps of:
transferring a pattern onto a substrate by use of an exposure apparatus as recited in claim 12; and
developing the substrate having the pattern transferred thereto.
